(19) United States
(12) Patent Application Publication
(10) Pub. No.: US 2026/0113196 A1
(43) Pub. Date: Apr. 23, 2026

(54) Trust-Based Reputation Scoring System for Verified Influence Networks

(71) Applicant: George William Bickerstaff, Greenwich, CT (US)

(72) Inventor: George William Bickerstaff, Greenwich, CT (US)

(21) Appl. No.: 19/306,923

(22) Filed: Aug. 21, 2025

(51) Int. Cl. H04L 9/32; H04L 9/00; H04L 9/40

(52) U.S. Cl. CPC H04L 9/3239; H04L 9/50; H04L 63/1425

(57) ABSTRACT

A trust-based reputation scoring system and method are provided for verified influence networks, such as social media platforms or organizational networks. The system integrates a computer-implemented framework that authenticates multi-source data using consensus corroboration and Z-score anomaly detection, calculates adaptive trust scores with exponential averaging and moving-average forecasting, and generates governance outputs via coalition alignment analysis using Balance, Centrality, and Cohesion Indices. Privacy is ensured through SHA-256 hashing and basic differential privacy. An interactive dashboard delivers secure, auditable insights. The architecture employs distributed storage with optional blockchain and federated learning, offering compliance-ready outputs with minimal complexity for applications in social influence or organizational trust.

### CROSS-REFERENCE TO RELATED APPLICATIONS

This application claims the benefit of U.S. Provisional Patent Application No. 63/847,240, filed Jul. 20, 2025, the entire contents of which are incorporated herein by reference.

### CPC CLASSIFICATIONS

G06Q 50/01: Organizational management; workflow; social networking
G06F 16/9535: Decision optimization with structured data; search customization based on user profiles
G06N 20/00: Machine learning; computational models

### BACKGROUND OF THE INVENTION

Reputation and trust scoring systems are common in social media analytics, organizational management, and e-commerce. Existing systems often rely on single-source data, leading to bias, manipulation risks, and lack of predictive insights. They typically lack integrated tools for coalition analysis or simplified privacy mechanisms suitable for influence networks, such as social platforms or corporate hierarchies. This invention addresses these deficiencies by providing:
1. Multi-source data validation using standard techniques;
2. Simplified privacy and audit safeguards;
3. Adaptive scoring with basic forecasting;
4. Governance analysis with unique network indices;
5. User-friendly dashboard for insights;
6. Scalable architecture with optional advanced features.

### DISTINCTIONS OVER PRIOR ART

This invention targets verified influence networks with a simplified, integrated system, distinguishing it from existing solutions:
Multi-source Validation: Unlike single-source systems (e.g., U.S. Pat. No. 8,869,245B2 for device reputation), it uses a Consensus Corroboration Unit (121) and Z-score-based Anomaly Detection (122) to ensure data integrity, reducing manipulation risks without complex machine learning.
Simplified Scoring: Employs exponential averaging and moving averages (unlike ARIMA-based models in U.S. Pat. No. 9,070,088B1), making it accessible for resource-constrained environments while producing forward-looking scores.
Cryptographic Auditability: Uses SHA-256 hashing (123) and basic differential privacy (124), simpler than advanced cryptographic systems (e.g., ShieldDFL, 2025), ensuring compliance with minimal overhead.
Governance Indices: Introduces Balance (trust distribution via weighted node contributions), Centrality (node degree for influence hubs), and Cohesion (clustering coefficients for connectivity), unique to influence network analysis, unlike generic trust models (e.g., BTRM, 2022).
Optional Federated Learning: Offers distributed model updates using standard frameworks (e.g., Flower), unlike mandatory complex federated learning in prior art (e.g., 2025 FL consensus models), enhancing implementation ease.

This combination of simplified validation, scoring, and network-specific indices sets it apart in a crowded field.

### SUMMARY OF THE INVENTION

The invention comprises a computer-implemented system with:
1. Data Ingestion and Validation Workflow: Authenticates multi-source inputs using consensus and Z-score checks.
2. Reputation Scoring Layer: Generates trust scores with exponential averaging and moving-average forecasting.
3. Governance Engine: Analyzes coalitions using Balance, Centrality, and Cohesion Indices.
4. System Architecture Overview: Delivers interactive, secure insights via dashboard.
5. End-to-End System Architecture: Integrates distributed storage, optional blockchain, and federated learning.

### BRIEF DESCRIPTION OF THE DRAWINGS

FIG. 1: Illustrates the Data Ingestion and Validation Workflow, detailing multi-source data processing and validation modules.

FIG. 2: Depicts the Reputation Scoring and Integration Layer, showing trust-weighted scoring and forecasting components.

FIG. 3: Shows the Governance and Group Engine, including coalition formation and alignment analysis.

FIG. 4: Presents the System Architecture Overview, highlighting dashboard user interface components.

FIG. 5: Provides an overview of the End-to-End System Architecture, integrating all components.

### DETAILED DESCRIPTION

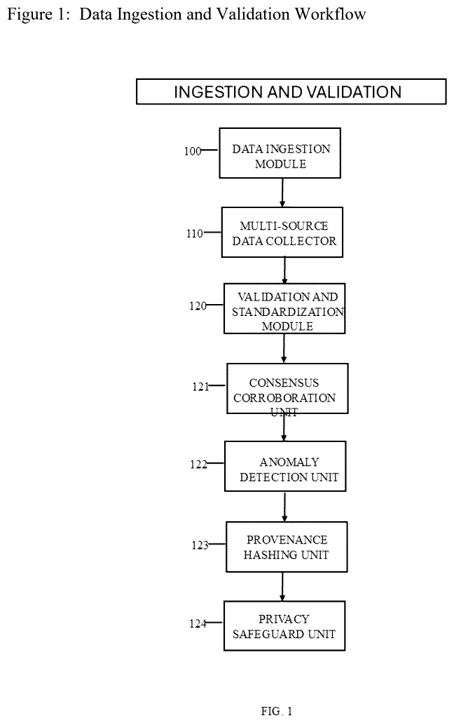

### Data Ingestion and Validation Workflow (FIG. 1)

The Data Ingestion Module (100) and Multi-Source Data Collector (110) aggregate data from sources like social media metrics, organizational logs, or transaction records in formats such as JSON or CSV. The Validation and Standardization Module (120) processes inputs through:
Consensus Corroboration Unit (121): Cross-validates data across sources by comparing values to ensure consistency (e.g., matching user influence scores from multiple platforms).
Anomaly Detection Unit (122): Applies Z-score analysis to identify outliers, using standard statistical thresholds (e.g., |Z|>2).
Provenance Hashing Unit (123): Generates tamper-evident ledger entries using SHA-256 hashing, implemented via standard libraries (e.g., Python's hashlib).
Privacy Safeguard Unit (124): Applies basic differential privacy by adding controlled noise to outputs, using libraries like diffprivlib.

Example: A record “EntityX|2025-08-01|Score=0.72” is validated, hashed with SHA-256, and stored in the Storage and Ledger (600), producing an auditable entry.

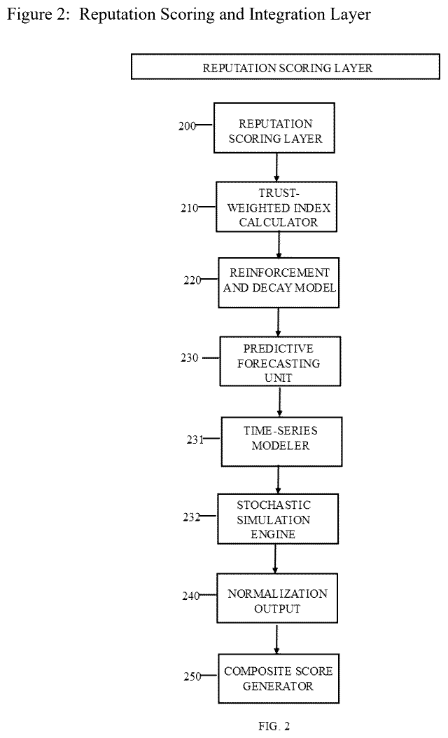

### Reputation Scoring and Integration Layer (FIG. 2)

The Reputation Scoring Layer (200) includes:
Trust-Weighted Index Calculator (210): Assigns weights to data sources based on reliability (e.g., higher weights for verified platforms).
Reinforcement and Decay Model (220): Adjusts scores using exponential averaging

$$( e . g . , score\_t = α * new\_score + ( 1 - α ) * score\_ ( t - 1 ) , α = 0.3 ) .$$

Predictive Forecasting Unit (230): Uses moving averages for forecasting via Time-Series Modeler (231) (e.g., simple moving average over 5 periods) and Stochastic Simulation Engine (232) for basic probability distributions (e.g., 100 runs).
Normalization Output (240): Scales scores to [0,1] for consistency.
Composite Score Generator (250): Combines weighted scores into a final reputation score, incorporating Balance (trust distribution via weighted node contributions), Centrality (node degree in a graph), and Cohesion (clustering coefficients) Indices.

Example: Scores [0.45, 0.47, 0.50, 0.52, 0.55] yield a moving-average forecast of 0.58, with indices computed using graph algorithms (e.g., NetworkX).

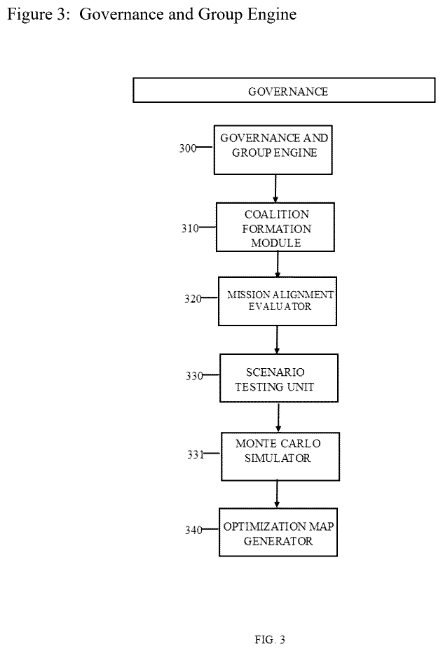

### Governance and Group Engine (FIG. 3)

The Governance Engine (300) comprises:
Coalition Formation Module (310): Models group structures based on trust scores, using graph representations.
Mission Alignment Evaluator (320): Assesses coalition alignment with objectives (e.g., maximizing collective trust).
Scenario Testing Unit (330): Uses a basic Monte Carlo Simulator (331) for resilience analysis (e.g., 100 runs to estimate alignment stability).
Optimization Map Generator (340): Produces visual maps of coalition strategies using indices.

Example: A coalition of 12 entities with trust 0.65 yields a mean alignment of 0.62 via basic simulation, with Balance, Centrality, and Cohesion Indices plotted.

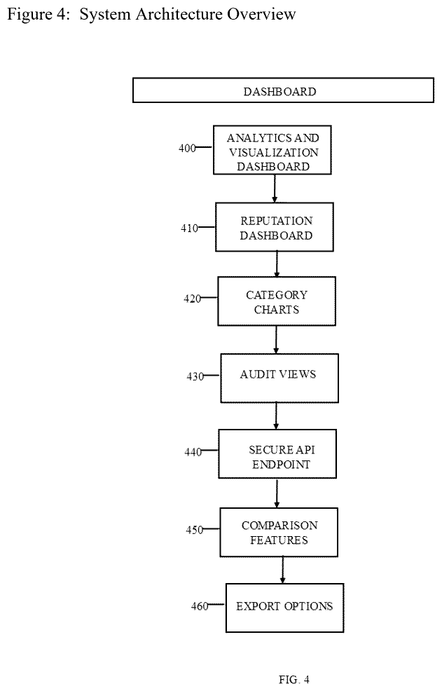

### System Architecture Overview (FIG. 4)

The Dashboard (400) provides:
Reputation Dashboard (410): Displays trust scores and indices (Balance, Centrality, Cohesion).
Category Charts (420): Visualizes metrics using standard tools (e.g., Plotly).
Audit Views (430): Shows hashed ledger entries for compliance.
Secure API Endpoint (440): Enables regulator access with role-based controls (e.g., OAuth).
Comparison Features (450): Benchmarks entities (e.g., comparing influence scores).
Export Options (460): Supports CSV/PDF exports.

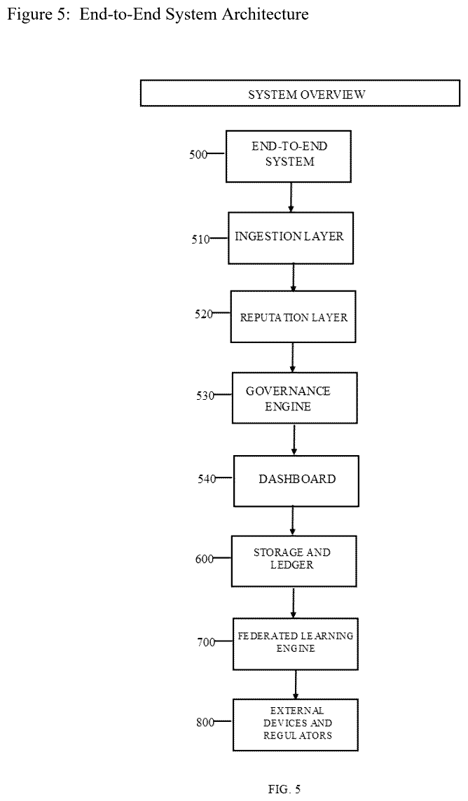

### End-to-End System Architecture (FIG. 5)

The System (500) integrates:
Ingestion Layer (510): Handles data input and validation.
Reputation Layer (520): Computes trust scores.
Governance Engine (530): Analyzes coalitions.
Dashboard (540): Delivers insights.
Storage and Ledger (600): Stores data, optionally on a blockchain (e.g., Ethereum).
Federated Learning Engine (700): Optionally retrains models using frameworks like Flower with secure aggregation.
External Devices and Regulators (800): Provides logged access via secure APIs.

1. An end-to-end system for trust-based reputation scoring in verified influence networks, comprising: a Data Ingestion Layer (510) including a Data Ingestion Module (100), Multi-Source Data Collector (110), and Validation and Standardization Module (120) with Consensus Corroboration Unit (121) for cross-validation, Anomaly Detection Unit (122) using Z-score analysis, Provenance Hashing Unit (123) with SHA-256, and Privacy Safeguard Unit (124) with differential privacy; a Reputation Scoring Layer (520) with Trust-Weighted Index Calculator (210), Reinforcement and Decay Model (220) using exponential averaging, Predictive Forecasting Unit (230) with Time-Series Modeler (231) using moving averages, Stochastic Simulation Engine (232), Normalization Output (240), and Composite Score Generator (250) producing Balance, Centrality, and Cohesion Indices; a Governance Engine (530) with Coalition Formation Module (310), Mission Alignment Evaluator (320), Scenario Testing Unit (330) with Monte Carlo Simulator (331), and Optimization Map Generator (340); a Dashboard (540) with Reputation Dashboard (410), Category Charts (420), Audit Views (430), Secure API Endpoint (440), Comparison Features (450), and Export Options (460); a Storage and Ledger (600) for auditable records; an optional Federated Learning Engine (700) using secure aggregation; and External Devices and Regulators (800) with secure access.

2. A system for calculating trust-based reputation scores in verified influence networks, comprising a Reputation Scoring Layer (200) with: a Trust-Weighted Index Calculator (210) assigning source reliability weights; a Reinforcement and Decay Model (220) applying exponential averaging; a Predictive Forecasting Unit (230) with a Time-Series Modeler (231) using moving averages; a Normalization Output (240); and a Composite Score Generator (250) producing Balance, Centrality, and Cohesion Indices, wherein Balance measures trust distribution via weighted node contributions, Centrality measures node degree, and Cohesion measures clustering coefficients.

3. A method for trust-based reputation scoring in verified influence networks, comprising: a. Ingesting and validating multi-source data using modules (100-124) with consensus corroboration and Z-score anomaly detection; b. Calculating trust-based reputation scores using modules (200-250) with exponential averaging and moving-average forecasting, producing Balance, Centrality, and Cohesion Indices; c. Performing governance analysis using modules (300-340) for coalition alignment with said indices; d. Delivering results via a dashboard using modules (400-460); e. Storing data and audit trails in a ledger (600); f. Optionally retraining models using a Federated Learning Engine (700); g. Providing regulator access via secure interfaces (800).

4. The system of claim 1, wherein the Provenance Hashing Unit (123) applies SHA-256 for tamper-evident ledger entries.

5. The system of claim 1, wherein the Privacy Safeguard Unit (124) applies differential privacy by adding controlled noise to outputs.

6. The system of claim 1, wherein the Anomaly Detection Unit (122) employs Z-score analysis with a threshold of |Z|>2.

7. The system of claim 1, wherein the Storage and Ledger (600) optionally publishes records to a blockchain using a platform like Ethereum.

8. The system of claim 2, wherein the Reinforcement and Decay Model (220) applies exponential averaging with a smoothing factor of 0.3.

9. The system of claim 2, wherein the Predictive Forecasting Unit (230) employs a 5-period moving average for time-series forecasting.

10. The method of claim 3, wherein hashing in module (123) applies SHA-256.

11. The method of claim 3, wherein forecasting in module (230) applies a 5-period moving average.
